(19) United States
(12) Patent Application Publication
(10) Pub. No.: US 2008/0089584 A1
(43) Pub. Date: Apr. 17, 2008

(54) VIEWING GLASS DISPLAY FOR MULTI-COMPONENT IMAGES

(76) Inventors: Richard L. VanMetter, Washington, DC (US); Jeffery H. Siewerdsen, Toronto (CA)

Correspondence Address: Patent Legal Staff;Eastman Kodak Company, 343 State Street, Rochester, NY, 14650-2201, US

(21) Appl. No.: 11/549,134

(22) Filed: Oct. 13, 2006

(51) Int. Cl. G06K 9/34

(52) U.S. Cl. 382/173

(57) ABSTRACT

A method for displaying components of a multi-component image in which a smaller selected region of one image component of a multi-component image is superimposed upon a larger section of another image component of the same multi-component image. The method includes: providing a multi-component digital image having at least first and second image components; displaying the first image component of the digital image; selecting a region of interest from the first image component; selecting the second image-component that is to be viewed in the region of interest of the first image component; and replacing the first image component with the second image component in the selected region of interest.

### FIELD OF THE INVENTION

This invention relates in general to the processing and display of digital images and more particularly to the display and utilization of multi-component images containing a plurality of registered images.

### BACKGROUND OF THE INVENTION

Multi-component images can arise in many areas of imaging including medical imaging (optical specimen imaging, radiographic imaging), reconnaissance imaging (satellite or aerial photography) and pictorial imaging. One example is multi-spectral imaging in which multiple images of the same object are made using different wavelengths of radiation (light). Another example is in dual-energy imaging in radiography. In this application, materials of specific compositions are selectively removed from components of a multi-component image by means of appropriate decomposition techniques applied to multiple x-ray images acquired with x-rays having different energy spectra. An example is that of “bone” and “soft-tissue” component image components obtained from dual-energy acquisitions. Current displays provide side-by-side viewing of bone and soft-tissue component images on workstations with multiple displays, or sequential viewing as a stack of images on a single display. The ability to correctly locate the same position and thereby correlate features of interest on one image with those on another can be impaired by a lack of simultaneous overlying display.

U.S. Pat. No. 5,542,003 (Wofford), issued Jul. 30, 1996, describes a method and apparatus in which a medical image workstation provides an end-user interface which, when activated, windows and levels a whole image or a region of interest within the same image utilizing the pixel values within a selection area. This allows users to select a region of interest and cause the entire image to be reprocessed according to that region of interest.

U.S. Pat. No. 6,735,330 (Van Metter et al.), issued May 11, 2004, describes a method for automatically modifying the rendering of an image based on an analysis of pixels within a selected region of interest of the image. The display of a single component image is altered to allow the user to better visualize light and dark areas of the image.

U.S. Pat. No. 6,017,309 (Washburn et al.), issued Jan. 25, 2000, describes an ultra sound color flow imaging system to automatically scale the range of values that are mapped into the color (velocity) component of the display for color-doppler ultrasound images. In one concept, the automated scaling of several different possible data-sets (representing flow velocity, power, or variance) to a color map is determined by various analyses of the data histogram (general analysis, equalized histogram analysis or end point analysis). The data may be obtained from an ultrasound detector (a new image) or from computer memory (a stored image). In another concept, setting a threshold value for replacing the standard image (ultrasound B-scan) with the color-mapped data (representing flow velocity, power or variances) is based on the analysis of the data histogram (general analysis, equalized histogram analysis or end point analysis). The data may obtained be directly from an ultrasound detector (a new image) or from computer memory (a stored image).

None of these patents disclose or suggest the display of an alternate component of a multi-component dataset by means of a user selectable and movable region of interest.

### SUMMARY OF THE INVENTION

According to the present invention there is provided a solution to the problems and a fulfillment of the needs discussed above.

According to one aspect of the present invention there is provided a method for displaying components of a multi-component image in which a smaller selected region of one image component of a multi-component image is superimposed upon a larger section of another image component of the same multi-component image, comprising: providing a multi-component digital image having at least first and second image components; displaying said first image component of said digital image; selecting a region of interest from said first image component; selecting the second image-component that is to be viewed in the region of interest of said first image component; and replacing the first image component with the second image component in the selected region of interest.

According to another aspect of the present invention there is provided a method for displaying components of a multi-component image including a standard image component, a first anatomical structure image component and a second anatomical structure image component that have been generated from a dual-energy radiographic acquisition in which a smaller selected region of any one image component of this multi-component image is superimposed upon a larger section of any other image component of the same multi-component image comprising the steps of: providing a multi-component image including a standard image component, a first anatomical structure image component and a second anatomical structure image component that have been generated from a dual-energy radiographic acquisition; displaying one of said image components of said multi-component image; selecting a region of interest from said displayed image component; selecting another one of said image components that is to be viewed in the region of interest; and replacing the displayed image-component with said another one of said image components in the selected region of interest.

The invention provides a method for the simultaneous and registered display of selected components of a multi-component image. A viewing-glass display for multi-component images allows the user to rapidly overlay a small part of one image-component in registration with the full-size display of another image-component from the same multi-component image. The viewing-glass can be a window that is a fraction of the size of the original image that can be moved over the entire area of the full-size display. When the viewing-glass is activated, the full-size image is occluded in the area covered by the viewing-glass. Within the area covered by the viewing-glass, an alternate component from the multi-component image is displayed.

The ability to pass a “viewing glass” over a full-size display of one image component (original image component) while displaying another image component (alternate image component) within the “viewing glass” allows the user to preserve the context of the original image component while providing additional information about the object characteristics within the small “viewing-glass” region of interest by means of the alternate image component.

The invention has the several advantages. For example, the context of the original displayed image is maintained by operating only on the selected region of interest, the remainder of the image is unchanged. In addition, the benefit of additional image information in the selected region of interest is obtained while the original displayed image in this region can be reviewed by simply moving the region of interest. The need to locate corresponding areas of multiple images on separate displays or on sequentially displayed images is avoided.

### BRIEF DESCRIPTION OF THE DRAWINGS

FIG. 1A is a block diagram showing an embodiment of the present invention.

FIG. 1B is a block diagram showing an apparatus for carrying out the present invention.

FIG. 1C is a diagrammatic view useful in explaining the present invention.

FIG. 2 is a standard image component of a dual energy multi component radiographic image.

FIG. 3 is a soft-tissue image component of a dual-energy multi-component radiographic image.

FIG. 4 is a bone image component of a dual-energy multi-component radiographic image.

FIG. 5 is a full size standard image component with viewing glass showing the bone image component of a selected region of interest.

FIG. 6 is a full size soft-tissue image component with viewing glass showing the gray-scale inverted bone image component in a selected region of interest.

FIG. 7 is a visible light reflection image of a laboratory animal used for experimentation showing the visible light component of a multi-component image.

FIG. 8 is a near infra-red fluorescence image showing sub-cutaneous tumors in the same laboratory animal shown in FIG. 7>shown is the fluorescence image component of a multi-component image.

FIG. 9 is a full size visible light component image with viewing glass showing the fluorescent image component in a selected region of interest containing fluorescent signals.

FIG. 10 is a full size visible light component image with viewing glass showing the fluorescence image component in a selected region of interest without visible fluorescent signals.

### DETAILED DESCRIPTION OF THE INVENTION

In general, the invention provides a method for the simultaneous and registered display of selected components of a multi-component image. The invention provides additional information about the characteristic of imaged objects by allowing the user to rapidly overlay a small part of one image-component in registration with the full-size display of another image-component from the same multi-component image. The viewing-glass can be a window that is a fraction of the size of the original image that can be moved over the entire area of the full-size display. When the viewing-glass is activated, the full-size image is occluded in the area covered by the viewing-glass. Within the area covered by the viewing-glass, an alternate component from the multi-component image is displayed.

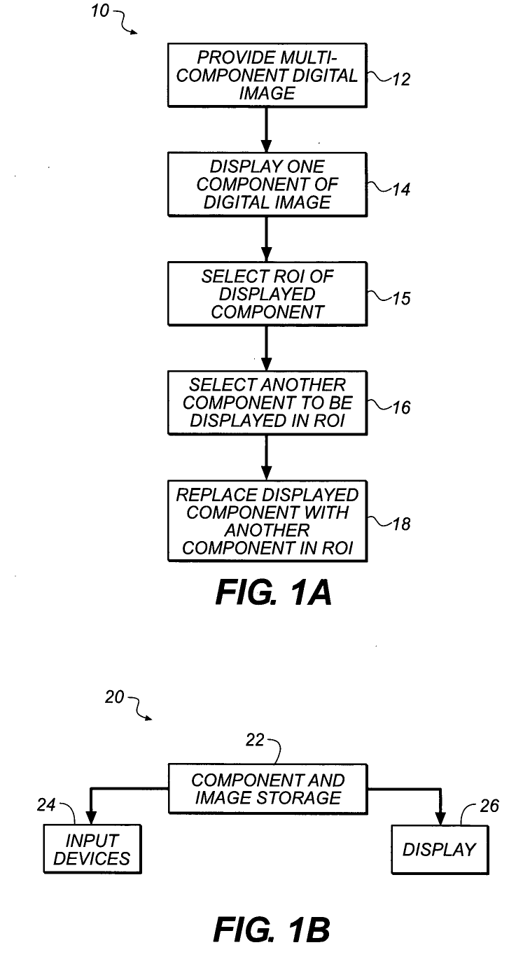

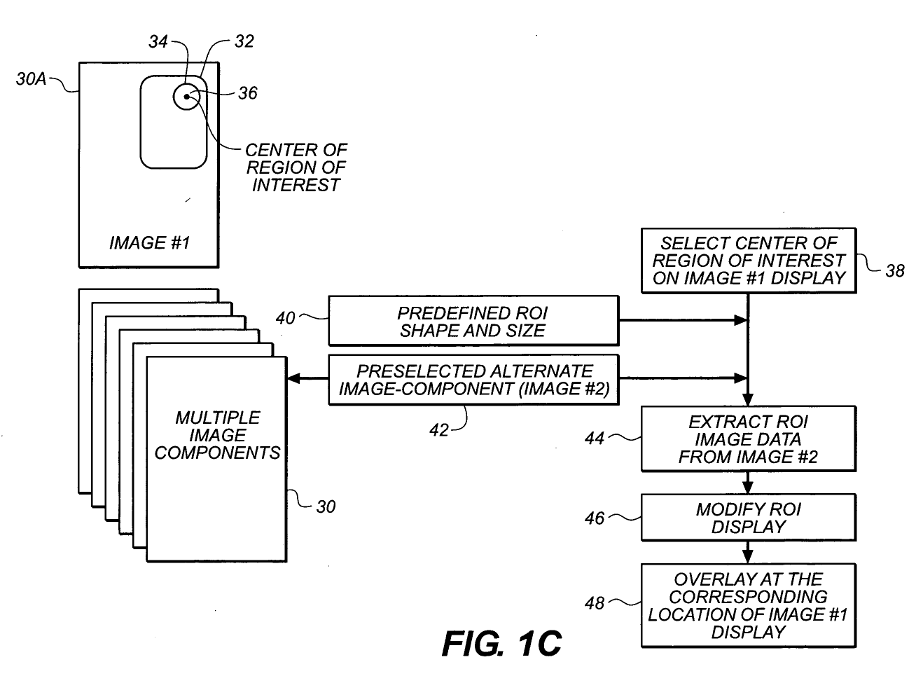

FIG. 1A shows an embodiment of the method of the present invention for displaying components of a multi-component image in which a smaller selected region of one image-component of a multi-component image is superimposed upon a larger section of another image-component of the same multi-component image. As shown, method 10 includes providing a multi-component digital image 12; displaying a first image component of the provided multi-component digital image 14; selecting a region of interest of the displayed first image component 15; selecting a second image component to be displayed in the region of interest 16; and replacing the displayed first image component with the selected second image component in the region of interest.

FIG. 1B shows exemplary apparatus for carrying out the present invention. As shown, apparatus 20 includes a display 22, input device(s) 24, such as a keyboard and pointing devices (mouse, track ball), and computer 26 having storage. Typically, apparatus 20 is a work station used for medical applications.

Referring now to FIG. 1C, there is shown in greater detail the present invention. Multiple image components 30 are stored in storage in computer 26. The multi-component image has an ordered multiplicity of values associated with each pixel, such that the respective value at each pixel represent different image of the same object. The multiple values may derive either from a single image acquisition or from multiple acquisitions. It is anticipated that image components derived from different acquisitions may require manipulation (for example, geometric warping) prior to being included as a component of a multi-component image. Multi-component images arise from a wide variety of sources. These include but are not limited to; dual-energy radiography, the color channels of a visible image (for example: red, green and blue), and satellite imagery consisting of multiple images taken with different spectral sensitivities. Sometimes multi-component images in medical imaging applications can be derived from independently acquired images that are registered to allow them to be used as multi-component images. For example, CT, MRI, and PET images of the same patient are often acquired. Diagnosis is enhanced by using this data together. Current technology often shows on such modality as a color wash on another. The looking glass approach of the present invention allows a more quantitative and accurate assessment of each image component while preserving spatial correlations. Another multi-component imaging application is multi-spectral satellite imagery.

An image 30A (Image #1) is selected for display on display 22. Only a region 32 of image 30A is displayed. A movable viewing glass 34 is formed on image region 32 and is movable by input device 24, such as a pointing device (mouse). Viewing glass 34 defines a region of interest 36 on image component 30A.

### Activating the Viewing Glass

A method for activating the viewing glass 34 can include one or more of the following:

1. A menu selection from an area of the display containing the full set of user selectable image display tools.

2. A hot-key combination. For example, simultaneously pressing the alt-key and the m-key on the keyboard of the display workstation.

3. Using the mouse to right-click on an image whence a drop down menu would appear allowing the user to select the Viewing Glass.

### Selecting a Region of Interest 36 for the Viewing Glass 34

The region of interest (ROI) 36 can be selected on a digital display apparatus 20 by means of a pointing device such as a mouse or trackball. The center of the region of interest is selected 38. A predetermined ROI shape and size—box 40 are selected. For example, a circle can be specified by selecting a circle icon from a menu by clicking the mouse while over that icon. The mouse is then moved to the point intended as the center of the circle where a button is depressed. The mouse is then dragged to the point that is intended to be on the circumference of the circle and the button released. The rectangle can be formed in a similar way. A rectangle icon is selected from a menu by clicking the mouse while over that icon. The mouse is then moved to one corner of the rectangle where a button is depressed. The mouse is then dragged to the point intended for the opposite corner of the rectangle and the button is released. An arbitrary polygon can be selected by first clicking the mouse over an appropriate icon on the menu. The mouse is then moved to the first intended vertex and clicked. This process is repeated for each vertex of the polygon. After each successive mouse click a line segment is shown which defines the boundary of that portion of the polygon. Double clicking at a vertex causes the polygon to be closed by connecting the last vertex point to the first.

Alternatively, the characteristics of the region of interest may be pre-defined as any geometrical shape and size. In this case, a mouse click is used to select a location on the image to which the region of interest will be applied. The location at which the mouse click occurs can be taken for example as the location for applying the center of the region of interest.

### Selecting an Alternate Image-Component

Multi-component images allow the selection of alternate image component for display in the region of interest defined by the “looking glass”. This selection can be done prior to selecting the looking glass tool. A default, preselected alternate image component—box 42 (Image #2) can be prescribed by the display program. This selection will in general depend on the type of image being displayed. For example, when viewing the “standard” image component of a dual-energy multi-component image, the default alternate image component may be the “bone” image component. However, when viewing the “bone” image component, the default alternative image component may be the soft tissue image component. The alternative image component for the looking glass can be changed by the user. For example, by right clicking on the looking glass a menu would be presented from which a new alternative image component would be selected. This selection would remain in effect until changed again by the user.

### Action of the Viewing Glass

Within the region of interest defined by the viewing glass, the corresponding part of an alternate image-component is displayed in registration with the full-size display of the original image-component from the same multi-component image. (This is effected by extracting the ROI image data from Image # 2—box 44, modifying the ROI display—box 46, and overlaying the corresponding location of the Image # 1 display—box 48). The viewing-glass appears as a window that is a fraction of the size of the original image that can be moved over the entire area of the full-size display. When the viewing-glass is activated, the full-size image is occluded in the area covered by the viewing-glass. Within the area covered by the viewing-glass, an alternate component from the multi-component image is displayed.

### Moving the Viewing Glass

After a region of interest has been selected and the viewing-glass display is activated, the alternate image component is displayed within the region of interest and the original image component is displayed outside the region of interest. The region of interest may be moved by “dragging” it to a new location on the original image component. In one embodiment, dragging may be accomplished by moving the cursor over the region of interest, depressing a mouse button and while depressed moving the cursor to the new location. An alternative embodiment is to move the cursor to a new location on the original image and click the mouse button. In any case, when the region of interest is re-located, the image content of the region of interest is updated to display the area of the alternative image component corresponding to the new location of the original image. The original image is now occluded in the new region of interest and is restored in the previous region of interest.

### Deactivating the Viewing Glass

A suitable means of de-activating the looking glass is employed. This can include one or more of the following:

1. A menu selection from an area of the display containing the full set of user selectable image display tools.

2. A hot-key combination. For example, simultaneously pressing the alt-key and the m-key on the keyboard of the display workstation.

3. A single keystroke. For example, pressing the esc-key on the keyboard of the workstation.

4. Using the mouse to right-click on an image whence a drop down menu would appear allowing the user to de-select the Viewing Glass.

The method of the invention and the purpose and advantage of the Viewing Glass can be appreciated by considering some examples of its use.

### Dual-Energy Subtraction Radiographic Images

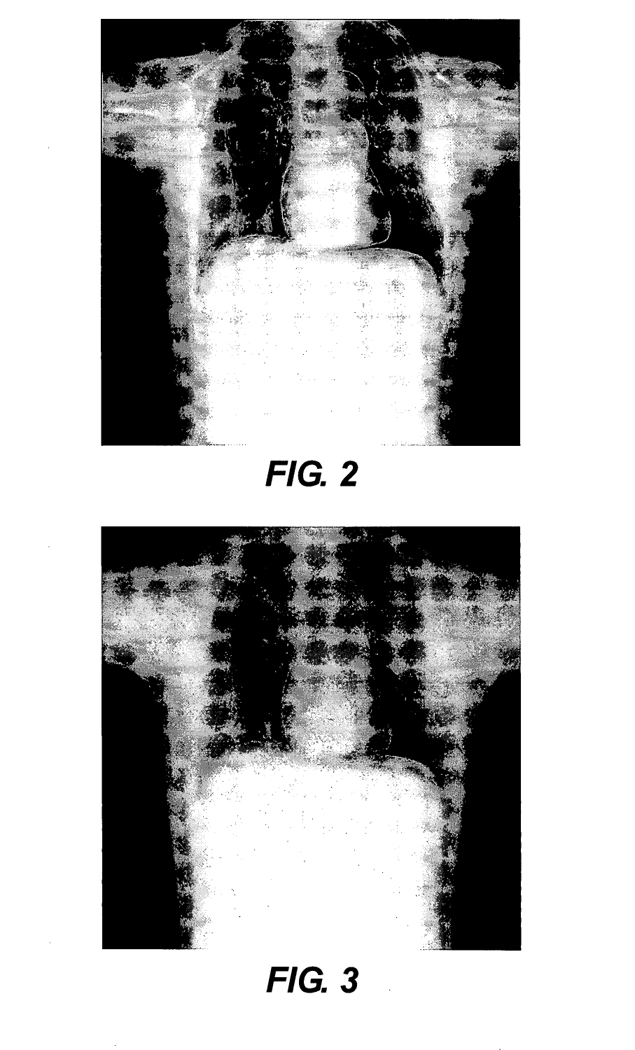

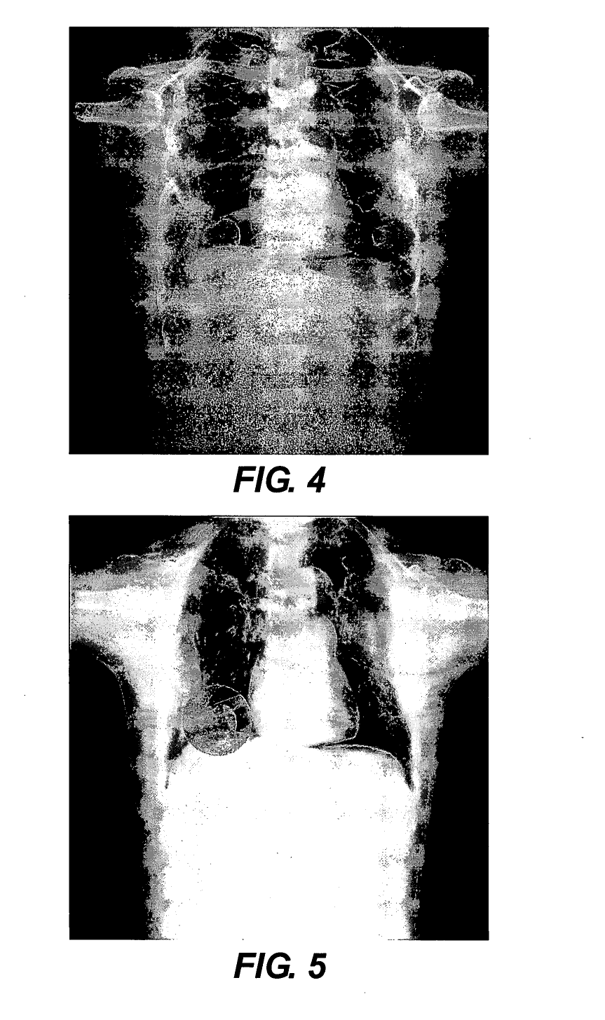

Dual-Energy subtraction is a well known method for using high- and low-energy x-ray images of a subject to produce display-ready images in different anatomical structures, such as bone and soft-tissue, in which either the bone or the soft-tissue contrast is selectively eliminated. The dual-energy acquisition can also produce a standard radiographic display-ready image similar in appearance to a conventional radiographic image. A standard radiographic image produced from a dual-energy acquisition is shown in FIG. 2. As expected, bone and soft-tissue are well visualized throughout the image. The soft-tissue component decomposition image is shown in FIG. 3. In this image, the bone contrast is substantially eliminated allowing improved visualization of soft-tissue details that are obscured by overlying boney structures in the standard radiographic image. The bone component decomposition image is shown in FIG. 4. This image consists primarily of contrast from calcified objects, such as bone or calcified tumors. Both the soft-tissue and bone component images provide substantial important diagnostic information. However, the significance of that information requires its spatial correlation to the normal anatomy best visualized in the standard radiographic display-ready image. The viewing-glass display allows the user to rapidly overlay a small part of one image-component in registration with the full-size display of another image-component from the same multi-component image. For example, FIG. 5 shows a small viewing-glass within which the bone image component is displayed and that can be moved over the entire area of the full-size display of the standard radiograph component image. In the example shown, the ability to appreciate the diagnostic significance of the calcified mass is substantially enhanced relative to the standard radiograph shown in FIG. 2. Most importantly, the viewing glass allows the spatial correlation to be maintained in the context of the anatomy depicted in the standard radiographic image.

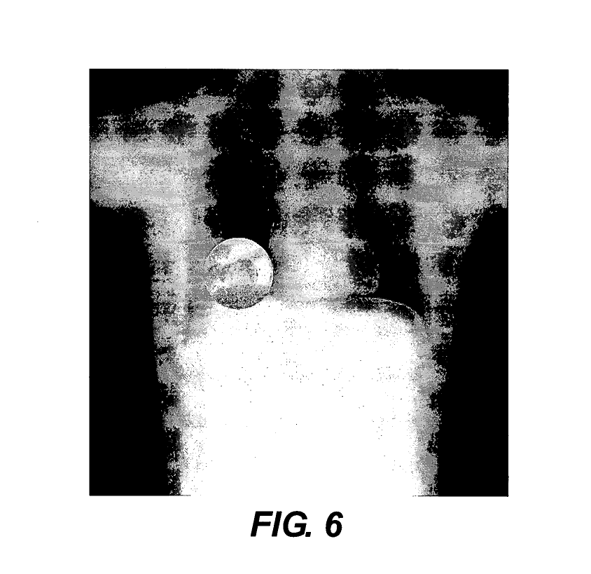

FIG. 6 shows another example in which a gray-scale inverted rendering of the bone image appears in the viewing glass within the context of the full soft-tissue image. This, for example, can be useful for assessing the calcification of lung nodules, an important diagnostic indicator.

### Multi-Spectral Imaging

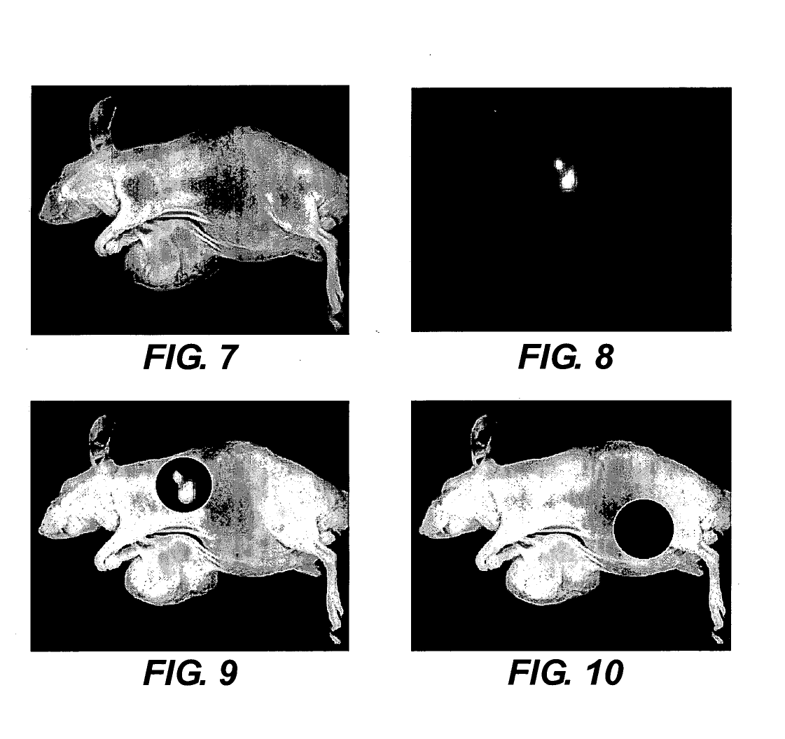

Many applications of multispectral imaging exist. FIG. 7 shows a visible light reflection image of a laboratory animal used for experimental purposes. In this example, the interest is in determining the location of sub-cutaneous tumors that have been marked with a near-infra-red fluorescent molecular tag. A registered image of the near-infra-red fluorescent signal is shown in FIG. 8 While various methods for combining the near-infra-red fluorescent image with the visible light image are used, these invariably corrupt both images and limit the sensitivity of detecting small signals. For example, the gray-scale values of the images can be summed of false color rendering of one of the images can be used. The viewing-glass display allows the user to rapidly overlay a small part of the fluorescence image component in registration with the full-size display of the visible light image component as shown in FIG. 9. The precise location of the sub-cutaneous tumors can be appreciated in the context of the animals anatomy provided by the visible light image. The absence of the visible light image within the viewing glass area allows the full sensitivity of the near-infra-red fluorescence signals to be appreciated.

FIG. 10 illustrates the result of moving the viewing glass to a different part of the image in which no near-infra-red fluorescent signal is present. The lack of interfering background associated with the visible light image increases the sensitivity for detecting subtle near-infra-red signals.

It is noted that a multi-component image refers to an image having a set of values associated with each pixel, such that the respective value at each pixel represent different image of the same object. The multiple values can derive either from a single image acquisition or from multiple acquisitions. It is notes that image components derived from different acquisitions can require manipulation (for example, geometric warping) prior to being included as a component of a multi-component image.

An image component is one set of pixel values of a multi-component image.

An original image component is the component of a multi-component image that is being displayed and that continues to be displayed in the areas except those included in the viewing glass.

An alternate image component is the component of a multi-component image, different than the original image component, that is displayed within the area of the viewing glass.

The term mouse or computer mouse is intended to represent a suitable pointing/selecting device used in the context of a computer display for selecting locations and initiating predefined action.

The invention has been described in detail with particular reference to certain preferred embodiments thereof, but it will be understood that variations and modifications can be effected within the spirit and scope of the invention.

### PARTS LIST

10—method of the invention
12, 14, 15, 16, 18—method steps
20—apparatus
22—display
24—input device(s)
26—computer and image storage
30—multiple image components
30A—image #1
32—region of image being displayed
34—viewing glass
36—region of interest
38—center of region of interest
40, 42, 44, 46, 48—method steps

1. A method for displaying components of a multi-component image in which a smaller selected region of one image component of a multi-component image is superimposed upon a larger section of another image component of the same multi-component image, comprising;
providing a multi-component digital image having at least first and second image components;
displaying the first image component of the digital image;
selecting a region of interest from the first image component;
selecting the second image-component that is to be viewed in the region of interest of the first image component; and
replacing the first image component with the second image component in the selected region of interest.

2. The method of claim 1 in which the size and shape of the selected region of interest is selected by a pointing device.

3. The method of claim 1 wherein the region of interest is:
a circular region defined by a center point and radius which is completely or partially contained within the image;
a rectangular region defined by two opposite corners; or
a polygonal region defined by an ordered set of vertices connected by non-intersecting straight line segments.

4. The method of claim 1 in which the size and shape of the selected region of interest is pre-selected and the center of the region of interest is selected by a pointing device.

5. The method of claim 1 in which the first image component is preselected.

6. The method of claim 1 in which the second image component is altered by means of one or more of the following: a look-up table, a smoothing filter, or edge-enhancement filter.

7. The method of claim 1 in which the center of the region of interest can be moved by means of a pointing device.

8. A method for displaying components of a multi-component image including a standard image component, a first anatomical structure image component and a second anatomical structure image component that have been generated from a dual-energy radiographic acquisition in which a smaller selected region of any one image component of this multi-component image is superimposed on a larger section of another image component of the same multi-component image, comprising:
providing a multi-component image including a standard image component, a first anatomical structure image component and a second anatomical structure image component that have been generated from a dual-energy radiographic acquisition;
displaying one of the image components of the multi-component image;
selecting a region of interest from the displayed image component;
selecting another one of the image components that is to be viewed in the region of interest; and
replacing the displayed image-component with the another one of the image components in the selected region of interest.

9. The method of claim 8 in which the smaller selected region displays the first anatomical structure image component and the larger section displays the standard-image component.

10. The method of claim 8 in which the smaller selected region displays the second anatomical structure image component and the larger section displays the standard-image component.

11. The method of claim 8 in which the smaller selected region displays the first anatomical structure image component and the larger section displays the second anatomical image component.

12. The method of claim 8 in which the size and shape of the selected region of interest is selected by a pointing device.

13. The method of claim 8 wherein the region of interest is:
a circular region defined by a center point and radius which is completely or partially contained within the image;
a rectangular region defined by two opposite corners; or
a polygonal region defined by an ordered set of vertices connected by non-intersecting straight line segments.

14. The method of claim 8 in which the size and shape of the selected region of interest is pre-selected and the center of the region of interest is selected by a pointing device.

15. The method of claim 8 in which the alternate image-component is preselected.

16. The method of claim 8 in which the center of the region of interest can be moved by means of a pointing device.

17. The method of claim 8 wherein the first anatomical structure image component is bone image component and the second anatomical structure is soft-tissue image component.
